(19) United States
(12) Patent Application Publication
(10) Pub. No.: US 2025/0108347 A1
(43) Pub. Date: Apr. 3, 2025

(54) OILFIELD SERVICE SLURRY AND PROPPANT BLENDING TUB

(71) Applicant: STEWART & STEVENSON LLC, Houston, TX (US)

(72) Inventor: Harrison SMITH, Houston, TX (US)

(21) Appl. No.: 18/896,024

(22) Filed: Sep. 25, 2024

Related U.S. Application Data
(60) Provisional application No. 63/541,676, filed on Sep. 29, 2023.

(51) Int. Cl. B01F 33/502; B01F 23/50; B01F 23/53; B01F 27/906; B01F 35/32; B01F 35/33; B01F 35/53; B01F 101/49; E21B 41/00

(52) U.S. Cl. CPC B01F 33/5023; B01F 23/53; B01F 23/565; B01F 27/906; B01F 33/5026; B01F 35/3204; B01F 35/33; B01F 35/5312; E21B 41/00; B01F 2101/49

(57) ABSTRACT

A modular blender system includes a trailer or skid and a blender assembly mounted on the trailer or skid, the blender assembly including a blender tub. The blender tub includes an upper portion, the upper portion having an upper lip in an interior of the blender tub and a plurality of strakes, the plurality of strakes extending from the upper lip.

### CROSS-REFERENCE TO RELATED APPLICATIONS

This application is a nonprovisional application which claims priority from U.S. provisional application No. 63/541,676, filed Sep. 29, 2023, which is incorporated by reference herein in its entirety.

### TECHNICAL FIELD/FIELD OF THE DISCLOSURE

The present disclosure relates generally to well service equipment and specifically to equipment used with well fluids.

### BACKGROUND OF THE DISCLOSURE

During drilling, completion, and production operations, fluids are circulated through a wellbore. Various chemicals and materials are introduced into the fluids, referred to herein as the slurry, to produce slurries having desirable characteristics. Examples of chemicals and materials include dry proppants, such as sand, fluids, and gels.

### SUMMARY

A modular blender system is disclosed. The modular blender system includes a trailer or skid and a blender assembly mounted on the trailer or skid, the blender assembly including a blender tub. The blender tub includes an upper portion, the upper portion having an upper lip in an interior of the blender tub and a plurality of strakes, the plurality of strakes extending from the upper lip.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a depiction of modular blender system consistent with certain embodiments of the present disclosure.

FIG. 2 is a detailed view of the modular blender system focused on the strakes consistent with certain embodiments of the present disclosure.

FIG. 3 is a perspective view of the modular blender system including the trailer consistent with certain embodiments of the present disclosure.

FIG. 4 is a cross-sectional view of the modular blender system consistent with certain embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

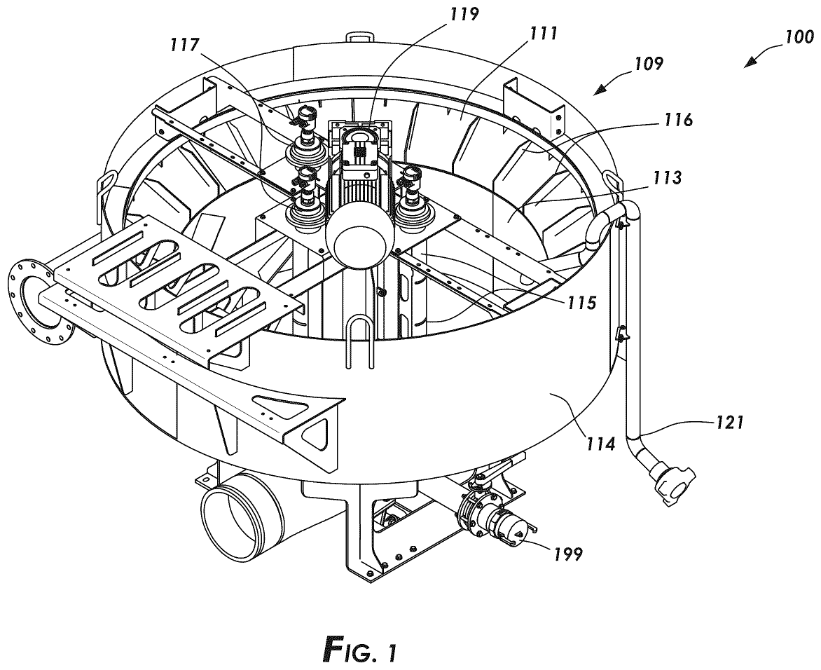

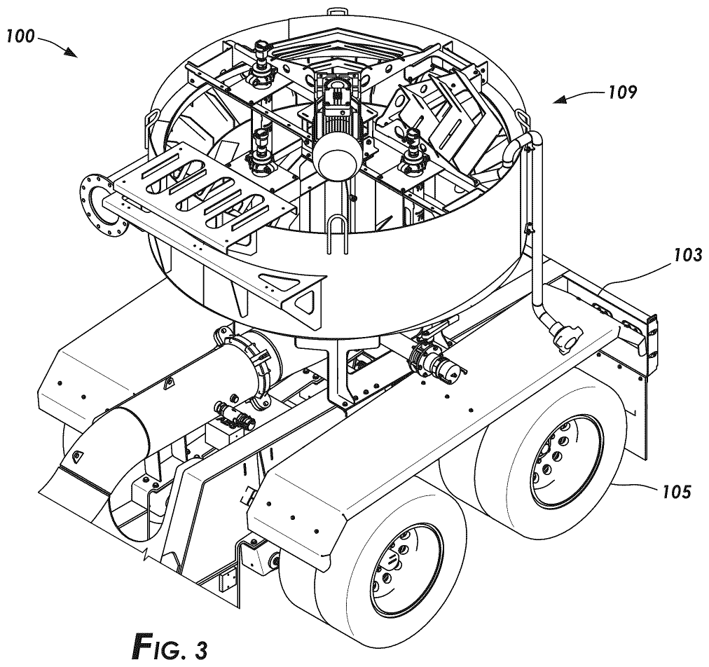

FIGS. 1-4 depict modular blender system 100. Modular blender system 100 may be used to prepare fluids for use in wellbore operations including stimulation operations such as hydraulic fracturing operation. For the purposes of this disclosure and without any intent to limit the scope of this disclosure, the fluids prepared by modular blender system 100 are referred to herein as a slurry made up of ingredients, chemicals, products, and base fluids as understood in the art such as, for example and without limitation, friction reducer, high viscosity friction reducer, guar or synthetic gel, inhibitors, PH buffers, proppant, and biocides.

Modular blender system 100 may include blender assembly 109. Blender assembly 109 may be adapted to mix one or more ingredients, chemicals, and products with a base fluid to generate a slurry used, for example and without limitation, in a wellbore stimulation operation such as a hydraulic fracturing operation. Blender assembly 109 may include blender tub 111, which defines mixing chamber 113. Blender tub 111 may be a vessel into which ingredients, chemicals, products, and base fluids may be introduced and mixed. In some embodiments, blender assembly 109 may include one or more blender paddles 115 positioned within mixing chamber 113 and rotatably driven by tub paddle motor 117. In some embodiments, tub paddle motor 117 may be an electric motor. In some embodiments, tub paddle motor 117 may operatively couple to blender paddles 115 via paddle gearbox 119. Blender paddles 115 may, as they rotate within mixing chamber 113, agitate and mix the ingredients, chemicals, products, and base fluids introduced thereinto to prepare the slurry. In some embodiments, blender tub 111 may include outlet 199 positioned at the base of blender tub 111. In some embodiments, base fluids may be introduced into blender tub 111 via supply pipe 121 coupled thereto.

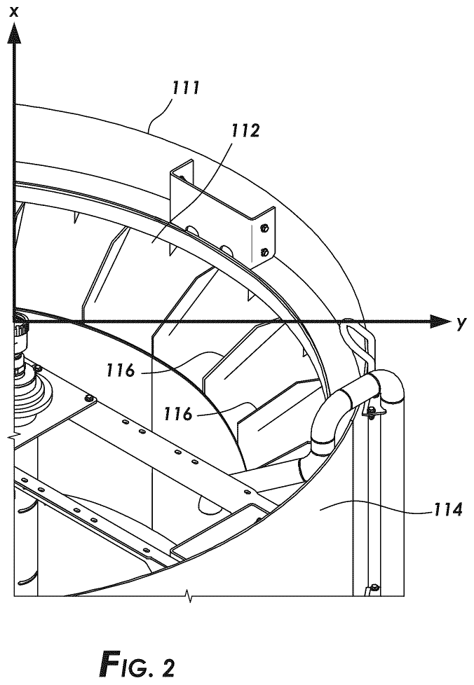

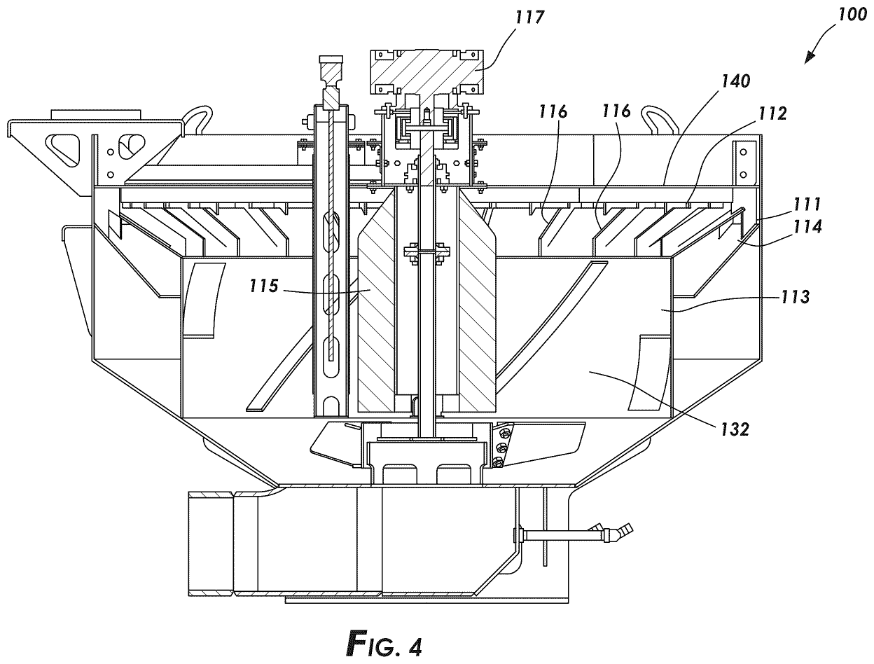

As shown in FIGS. 1 and 4 and detailed in FIG. 2, blender tub 111 may also include upper lip 112 positioned within blender tub 111. Upper lip 112 is positioned on upper portion 114 of blender tub 111. Upper lip 112 provides spillover relief/overflow protection for blender tub 111.

Extending from upper lip 112 are a plurality of strakes 116. Strakes are protruding ridges from upper lip 112. Strakes 116 encourage turbulent flow within blender tub 111 from outer tub 140 to inner tub 132. Turbulent flow may be preferred to laminar flow because the friction and agitation of turbulent flow may facilitate proppant suspension in the slurry. Strakes 116 also provide reinforcement to maintain blender tub 111 structural integrity.

FIG. 2 depicts the horizontal axis y of a horizontal plane of blender tub 111. The angle (relative to the horizontal plane of blender tub 111) of strakes 116 and number of strakes 116 encourage an even flow of pressurized water as compared to traditional tubs without strakes 116. The angle of strakes 116 may be between 20 and 45 degrees relative to the horizontal plane of blender tub 111.

In some embodiments, modular blender system 100 may include trailer 103. Trailer 103 may support components of modular blender system 100 and may provide for transportation of modular blender system 100 while allowing all components thereof to remain operatively coupled. In some embodiments, trailer 103 includes one or more wheels 105. In some such embodiments, trailer 103 may be a rockover trailer. In other embodiments, the modular blender system is mounted on a skid.

In some embodiments, modular blender system 100 may be operated remotely.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A modular blender system comprising:
a trailer or skid; and
a blender assembly mounted on the trailer or skid, the blender assembly including a blender tub, the blender tub including:
an upper portion, the upper portion having an upper lip in an interior of the blender tub;
an inner portion and outer portion; and
a plurality of strakes, the plurality of strakes extending from the upper lip.

2. The modular blender system of claim 1, wherein the upper lip is adapted to provide spillover relief and overflow protection for the blender tub.

3. The modular blender system of claim 1, wherein the strakes are adapted to cause turbulent flow within blender tub 111.

4. The modular blender system of claim 1, wherein the strakes are adapted to reinforce structural integrity of the blender tub.

5. The modular blender system of claim 1, wherein the strakes form an angle of between 20 and 45 degrees relative to a horizontal plane of the blender tub.

6. The modular blender system of claim 1, wherein the trailer is a rockover trailer.

7. The modular blender of claim 1 further comprising one or more blender paddles within the blender tub.

8. The modular blender tub of claim 7, wherein the one or more blender paddles are operatively coupled to one or more tub paddle motors.

9. The modular blender tub of claim 8, wherein the blender assembly further comprises a paddle gear box, the paddle gear box operatively coupled to the one or more tub paddle motors.

10. The modular blender system of claim 1, wherein the modular blender system is adapted to be operated remotely.

11. The modular blender system of claim 1 further comprising a supply connection, the supply connection positioned to introduce fluids into the blender tub.

12. The modular blender system of claim 1 further comprising an outlet, the outlet positioned at a base of the blender tub.
